(19) United States
(12) Patent Application Publication
(10) Pub. No.: US 2023/0005113 A1
(43) Pub. Date: Jan. 5, 2023

(54) METHOD AND SYSTEM FOR MEDICAL IMAGE DATA ENHANCEMENT

(71) Applicant: SHENZHEN KEYA MEDICAL TECHNOLOGY CORPORATION, Shenzhen (CN)

(72) Inventors: Guang LI, Beijing (CN); Jinchen LI, Beijing (CN); Chengwei SUN, Beijing (CN); Cong CHEN, Beijing (CN); Kunlin CAO, Kenmore, WA (US); Qi SONG, Seattle, WA (US)

(73) Assignee: SHENZHEN KEYA MEDICAL TECHNOLOGY CORPORATION, Shenzhen (CN)

(21) Appl. No.: 17/741,098

(22) Filed: May 10, 2022

(30) Foreign Application Priority Data
Jul. 5, 2021 (CN) 2021107547211

(51) Int. Cl. G06T 5/50; G06T 7/00; G06T 7/73; G06T 7/174

(52) U.S. Cl. CPC G06T 5/50; G06T 7/0012; G06T 7/74; G06T 7/174; G06T 2207/30096; G06T 2207/20221

(57) ABSTRACT

A method for medical image data enhancement is provided. The method includes: receiving a medical image sample set related to an object to be detected; based on an attribute of the object lacking in the medical image sample set, selecting a first medical image and a second medical image from the medical image sample set, where the first medical image contains the object lacking the attribute, and the second medical image does not contain the object lacking the attribute; determining a first area image block containing the lacking attribute; determining a second area image block not containing the lacking attribute; generating a composite area image block by fusing the first area image block and the second area image block based on a mask including an object part and a peripheral part around the object part; embedding the composite area image block back into the second medical image to obtain a third medical image; including the third medical image in the medical image sample set to obtain a data-enhanced medical image sample set.

### CROSS-REFERENCE TO RELATED APPLICATIONS

The application is based upon and claims the benefit of priority to Chinese Patent Application No. 2021107547211, filed Jul. 5, 2021, the entire content of which is incorporated herein by reference.

### TECHNICAL FIELD

The present disclosure relates to medical image processing, more specifically, to a method and system for medical image data enhancement for improving detection results.

### BACKGROUND

The automatic detection of lesions in a medical image can not only improve the reading efficiency of the doctors, but also provide quantitative information of lesions. At present, the lesion detection method based on deep learning has high robustness and accuracy, but lesions in the medical image are very widely distributed, and the training data cannot cover all the distribution of the lesions. Moreover, the imbalance between the proportions of positive and negative samples of a lesion type and anatomical position or the combination of the above factors will also have a great impact on the accuracy and generalization ability of deep learning. Therefore, data enhancement is the key to improve the lesion detection accuracy and model generalization ability.

At present, the more popular methods for image data enhancement include such as an overall transformation of the whole image by means of the image rotation, translation, zooming and flipping etc., Mix-up and Copy-Move. However, image overall transformation cannot add positive samples at different anatomical structure positions. Coping-Moving is to simply copy a lesion area in a positive sample image containing a certain type of lesion and move it into other negative sample images, which are then added to the medical image sample set as new positive samples. This method will leave obvious traces of image composition on the enhanced image. Compared with a real medical image sample containing the lesion, there is a large gap in the authenticity of the sample. Even when it is used in machine learning, it may cause additional adverse effects. Therefore, there is currently no sufficiently effective method for data enhancement for the imbalance between positive and negative samples in terms of lesion type and anatomical position or the like in the medical image sample set.

### SUMMARY

In view of the shortcomings of the prior arts, the present disclosure is provided to solve the above problems in the prior art.

There is a need for a method, a device for data enhancement for medical image detection, and a storage medium. The lack of the amount of samples of the object to be detected in terms of lesion type, position and size, etc., or the imbalance between positive and negative samples in the medical image sample set can be identified. And based on the identified lacking attribute of the object, a positive sample of the medical image that contains the object lacking the attribute and a negative sample of the medical image that does not contain the object lacking the attribute are selected in the medical image sample set respectively. And by using a masking based image block fusing algorithm, a composite area image block containing the object lacking the attribute after fusing process is embedded back into the negative sample of the medical image, which is added as a positive sample into the medical image sample set to achieve data enhancement for the medical image sample set. Therefore, the accuracy of detecting the object to be detected by using the medical image sample set after data enhancement, and the generalization ability of a deep learning model trained with this medical image sample set are improved.

According to a first aspect of the present disclosure, a method for medical image data enhancement is provided. The method may include receiving a medical image sample set related to an object to be detected. The method may further include, based on an attribute of the object lacking in the medical image sample set, selecting a first medical image and a second medical image from the medical image sample set, where the first medical image contains the object lacking the attribute, and the second medical image does not contain the object lacking the attribute. The method may further include determining a first area image block encompassing an area containing the object lacking the attribute in the first medical image. The method may further include determining a second area image block encompassing an area not containing the object lacking the attribute in the second medical image. The method may further include generating a composite area image block by fusing the first area image block and the second area image block based on a masking including an object part and a peripheral part around the object part. The method may further include embedding the composite area image block back into the second medical image to obtain a third medical image. The method may further include including the third medical image in the medical image sample set to obtain a data-enhanced medical image sample set.

According to a second aspect of the present disclosure, a device for medical image data enhancement is provided. The device may include a communication interface configured to receive a medical image sample set related to an object to be detected, and a processor. The processor is configured to, based on an attribute of the object lacking in the medical image sample set, select a first medical image and a second medical image from the medical image sample set, where the first medical image contains the object lacking the attribute, and the second medical image does not contain the object lacking the attribute. The processor is further configured to determine a first area image block encompassing an area containing the object lacking the attribute in the first medical image; and a determine a second area image block encompassing an area not containing the object lacking the attribute in the second medical image; and generate a composite area image block by fusing the first area image block and the second area image block based on a masking including an object part and a peripheral part around the object part. The processor is also configured to embed the composite area image block back into the second medical image to obtain a third medical image; and including the third medical image in the medical image sample set through the communication interface to obtain a data-enhanced medical image sample set.

According to a third aspect of the present disclosure, a non-transitory computer readable storage medium having computer executable instructions stored thereon is provided. The computer executable instructions, when executed by a processor, implement a method for medical image data enhancement. The method may include receiving a medical image sample set related to an object to be detected. The method may further include, based on an attribute of the object lacking in the medical image sample set, selecting a first medical image and a second medical image from the medical image sample set, where the first medical image contains the object lacking the attribute, and the second medical image does not contain the object lacking the attribute. The method may further include determining a first area image block encompassing an area containing the object lacking the attribute in the first medical image. The method may further include determining a second area image block encompassing an area not containing the object lacking the attribute in the second medical image. The method may further include generating a composite area image block by fusing the first area image block and the second area image block based on a masking including an object part and a peripheral part around the object part. The method may further include embedding the composite area image block back into the second medical image to obtain a third medical image. The method may further include including the third medical image in the medical image sample set to obtain a data-enhanced medical image sample set.

With the method, the device for medical image data enhancement, and the storage medium according to embodiments of the present disclosure, the imbalance of the attributes of the object to be detected in the medical image sample set can be identified. And based on the identified lacking attribute of the object, by using a masking based image block fusing algorithm, a composite medical image containing the object lacking the attribute is generated. The composite medical image generated by using the method described above is very close to the real medical image containing the object lacking the attribute, since the image fusing process was performed. The above-mentioned composite medical image, as a positive sample, is added into the medical image sample set, so that the medical image sample set with respect to the lacking attribute of the object can be comprehensively enhanced in terms of the amount of sample, the quality of sample, and adaptability of the sample to various scenarios, etc. Therefore, the accuracy of detecting the object to be detected by using the medical image sample set after data enhancement, and the generalization ability of a deep learning model trained with this medical image sample set are improved.

### BRIEF DESCRIPTION OF THE DRAWINGS

In the drawings, which are not necessarily drawn to scale, like numerals may describe similar components in different views. The drawings illustrate generally, by way of example instead of limitation, various embodiments, and together with the description and claims, serve to explain the disclosed embodiments. The same reference signs in all of the drawings are used to refer to the same or similar portions when appropriate. Such embodiments are demonstrative and not intended to be exhaustive or exclusive embodiments of the present device or method.

FIG. 1 shows a flow of a method for medical image data enhancement according to an embodiment of the present disclosure;

FIG. 2 illustrates a calculation method for a first fusing coefficient and a second fusing coefficient according to an example of an embodiment of the present disclosure;

FIG. 3 shows a schematic diagram of an example of fusing image blocks based on a masking according to an embodiment of the present disclosure;

FIG. 4 shows a comparison of the effects between a new nodule image generated by fusing the image blocks based on a masking according to an embodiment of the present disclosure and a new nodule image generated by a conventional manner of copy-move; and

FIG. 5 shows a schematic diagram of a device for medical image data enhancement according to an embodiment of the present disclosure.

### DETAILED DESCRIPTION

In order to enable those skilled in the art to better understand the technical solutions of the present disclosure, the present disclosure will be described in detail below in conjunction with the drawings and specific implementations. The present disclosure will be further described below in conjunction with the drawings and specific embodiments, but not as a limitation to the present disclosure. The order of the individual steps described herein as examples should not be viewed as a limitation if there is no need for a front-back relationship with each other, to which those skilled in the art should know that the order can be adjusted, as long as the logic therebetween may not be disrupted so that the entire flow can be achieved.

Furthermore, those skilled in the art should understand that the drawings provided herein are all for illustrative purposes and that the drawings are not necessarily drawn to scale.

Unless definitely required by the context, similar words such as “comprises” or “including” throughout the specification and claims should be construed as meaning inclusive rather than exclusive or exhaustive, that is, be the meaning “including but not limited to”.

In the description of the present disclosure, it is understood that the terms “first”, “second”, etc. are intended for descriptive purposes only and cannot be understood as indicating or suggesting relative importance. In addition, in the description of the present disclosure, unless otherwise stated, “multiple” means two or more.

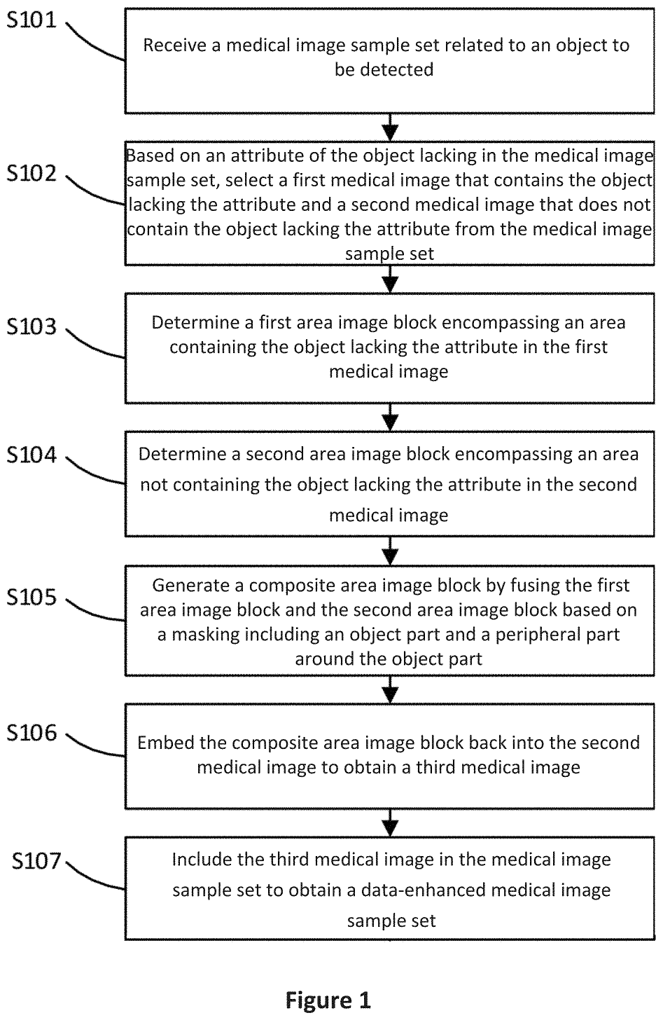

FIG. 1 shows a flow of a method for medical image data enhancement according to an embodiment of the present disclosure. As shown in FIG. 1, the flow may begin at step S101. At step S101, a medical image sample set related to an object to be detected is obtained at first. The medical image in the sample set may be either a three-dimensional medical image or a two-dimensional medical image, and no restrictions are made here. In some embodiments, the object to be detected may be any lesion that is applicable to the medical image, such as including but not limited to nodule, tumor, cyst, and hemorrhage lesion, etc.

At step S102, based on an attribute of the object lacking in the medical image sample set, a first medical image and a second medical image are selected from the medical image sample set, so that the first medical image contains the object lacking the attribute, while the second medical image does not contain the object lacking the attribute.

In some embodiments, the first medical image and the second medical image may be randomly selected from the medical image sample set. Specifically, the first medical image containing the object lacking the attribute and the second medical image not containing the object lacking the attribute may be selected from all sample images in the medical image sample set according to a certain random algorithm for subsequent data enhancement operations.

In some other embodiments, the first medical image and the second medical image may also be randomly selected from a subset of the medical image sample set. In some embodiments, for example, medical images that contain the lacking attribute of the object and are determined to have high image quality may be selected as a subset of the medical image samples. As another example, original, unprocessed images containing the lacking attribute of the object may also be selected as a subset of medical image samples, so as to suppress the cumulative deviation between the composite image and the real medical image that may be caused by multiple image fusing processes.

In some embodiments, the attribute of the object may be any attribute with diagnostic significance in clinical application, such as at least one or a combination of a subtype, a position, and a size of the object. In some embodiments, when the object is a pulmonary lesion, the subtype of the object may include a solid lesion, a ground-glass lesion or a semi-solid lesion, etc., and the position of the object may include the inside of the lung lobes or the inside of the thorax, etc. In some embodiments, the size of the object may be divided into large size, medium size and small size, etc., according to a clinical definition of different types of lesion.

In some embodiments, the attribute of the object lacking in the medical image sample set may be determined through a comparison with the actual distribution of the attributes of the object. For example, a lung solid lesion located in the thorax may be detected in clinical practice, while the medical image sample set does not have or only has a small number of images of the object containing such attribute, and it may be determined that the medical sample set lacks the attribute of being located in the thorax of the lung solid lesion object. In other embodiments, a determination of lack may also be made through a comparison with the proportions of the attributes of the object in clinical practice.

In some other embodiments, the attribute of the object lacking in the medical image sample set may also be determined by the following machine learning method. That is, the medical image is detected by using a model trained based on the medical image sample set to obtain a detection distribution of the attributes of the object, and then the detection distribution of the attributes of the object is compared with the actual distribution of the attributes of the object. When the detection of a certain type of attribute of the object is not ideal, it usually implies a lack of medical image samples containing the related attribute of the object during model training. Or, even if the poor detection effect is not caused by the lack of related attribute of the object in the sample set, from the perspective of result orientation, by increasing the number of image samples of the corresponding attribute of the object, the training effect of the model may also be improved.

Next, after determining the attribute of the object lacking in the medical image sample set, steps S103 to S107 may be performed for targeted data enhancement of the medical image sample set.

At step S103, an area containing the object lacking the attribute is identified in the selected first medical image as a first area image block.

At step S104, an area not containing the object lacking the attribute is identified in the second medical image as a second area image block.

In some embodiments, the first area image block may be selected as an area that centers on the center of the object to be detected and covers most area of the object to be detected, such as a square or a circle, to facilitate the subsequent image fusing process.

In some embodiments, when selecting the second area image block, the same size as the first area image block may be adopted to facilitate the subsequent image fusing process.

Next, at step S105, the first area image block and the second area image block are fused based on a masking including an object part and a peripheral part around the object part so as to obtain a composite area image block.

In some embodiments, a masking is defined to be used to perform a gradual fusing process of the first area image block and the second area image block, wherein the masking may include two parts, that is, an object part of the masking and a peripheral part around the object part.

In some embodiments, the object part of the masking may be set according to the shape and range of the object to be detected in the first area image block. In some other embodiments, for ease of calculation, a regular shape, such as a circle, that centers on the center of the object to be detected in the first area image block and covers main features of the object to be detected may be set as the object part of the masking.

In some embodiments, when setting the range of the peripheral part around the object part of the masking, the size thereof may be set to match the size of the first area image block. As an example, when the shape of the object part of the masking is the same as that of the first area image block, the boundary of the peripheral part around the object part may be set to overlap the boundary of the first area image block. In other embodiments, the peripheral part around the object part may be set as an area of which boundary shape is the same as that of the object part and the boundary has a constant distance from the boundary of the object part.

In some embodiments, the shape and size of the object part and the peripheral part around the object part of the masking may be determined according to the specific object to be detected. In some other representations, the shape and size of the masking may be adjusted according to the detection effect of the object to be detected after data enhancement.

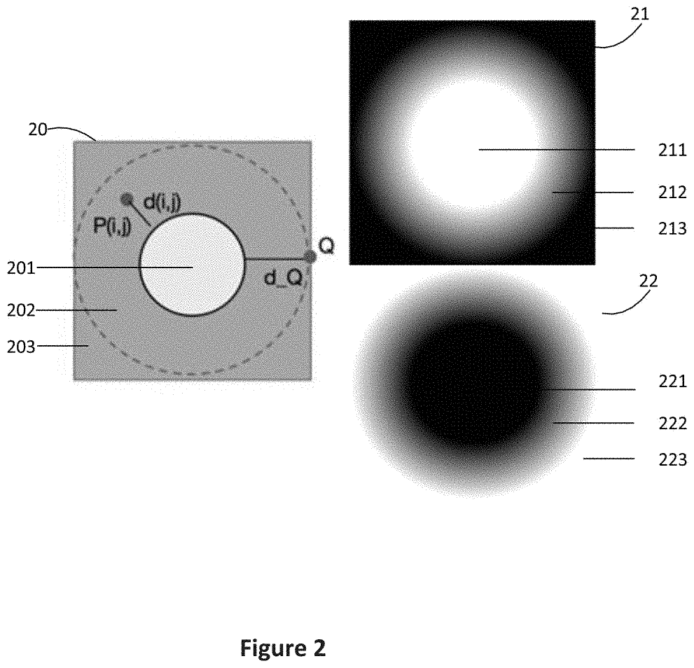

In some embodiments, when fusing the first area image block and the second area image block based on a masking including the object part and the peripheral part around the object part, for each position in each part of the masking, the image information of the corresponding position in the first area image block and the second area image block is fused based on a first fusing coefficient and a second fusing coefficient respectively. Various applicable calculation methods may be adopted for the above first fusing coefficient and the second fusing coefficient, which will be described in detail below in combination with the illustrations in FIG. 2.

Next, at step S106, the composite area image block generated based on the masking, the first area image block and the second area image block are embedded back into the second medical image to obtain a third medical image.

In some embodiments, multiple different composite area image blocks may be generated by using the same first area image block in the same first medical image and different second area image blocks in the same/different second medical images, and are then embedded back into the corresponding second medical image to obtain multiple third medical images.

At step S107, the third medical image is added into the medical image sample set to obtain a data-enhanced medical image sample set.

In some embodiments, the required multiple third medical images may be generated at a time in batch processing. After a complete round of training on the deep learning model with the medical image sample set, the multiple third medical images may be added into the medical image sample set in an offline manner, and the data-enhanced medical image sample set is used for the next round of training.

In some other embodiments, it is also possible to use, in an online manner at any time, the generated third medical image having the lacking attribute of the object for the update of the medical image sample set that is under training.

Through the above steps S101 to S107, the amount and diversity of samples having the lacking attribute of the object in the medical image sample set are increased. Therefore, the balance of the medical image sample set in a specific attribute of the object is enhanced, and the enhanced medical image sample set has higher detection accuracy and adaptability to different scenarios. The trained deep learning model also has stronger generalization ability.

In order to more clearly describe the specific algorithm of fusing the first area image block and the second area image block based on the masking, the calculation method of the first fusing coefficient and the second fusing coefficient will be further described in more detail in combination with FIG. 2 below.

FIG. 2 illustrates the calculation method of the first fusing coefficient and the second fusing coefficient according to an example of an embodiment of the present disclosure. For ease of description, in the example of FIG. 2, it is assumed that the selected first area image block and the second area image block have exactly the same shape and size, corresponding to an area 20 in FIG. 2.

In some embodiments, the first area image block contains an object to be detected, such as a nodule, tumor, cyst, and hemorrhage lesion. In FIG. 2, the object part 201 of the masking covers the most area of the object to be detected. It should be noted that the object part 201 of the masking is not necessarily a circle as shown in FIG. 2 or other regular shape, and it may also be any other shape determined according to the actual situation of the object to be detected in other embodiments.

In some embodiments, the peripheral part 202 around the object part of the masking may be defined based on a parameter d_Q. d_Q is the minimum distance from all points on the boundary of the peripheral part 202 around the object part of the masking to the boundary of the object part 201 of the masking. In some embodiments, the parameter d_Q may be defined as the distance from a point, among all points on the boundary of the area 20, having the smallest distance to the boundary of the object part of the masking, namely point Q in FIG. 2, to the boundary of the object part of the masking. For example, in the example of FIG. 2, in a case where the area 20 is a square and the object part 201 of the masking is a circle, the peripheral part 202 around the object part of the masking is the circular area with a ring width of d_Q outside of the object part 201 of the masking. Similarly, in some other embodiments, the shape of the peripheral part 202 around the object part of the masking may be determined based on the shape and the parameter d_Q of the object part 201 of the masking, and therefore is not limited to a ring or other regular shapes. The area 203 in FIG. 2 refers to other areas in the area 20 other than the object part 201 of the masking and the peripheral part 202 around the object part of the masking.

Based on the above definition of each area, a description is given to a calculation method of a first fusing coefficient value S₁(i,j) in the first fusing coefficient field 21 and a second fusing coefficient value S₂(i,j) in a second fusing coefficient field 22 at each position (i,j).

In the first fusing coefficient field 21 and the second fusing coefficient field 22 as shown in FIG. 2, the values of fusing coefficients for each position (i,j) are in a range of [0,1], wherein white represents a value of 1, black represents a value of 0, and other gray values represent values within (0,1). In some embodiments, S₁(i,j) for each position(i,j) in the area 211 of the first fusing coefficient field 21 corresponding to the object part 201 of the masking may be set as 1, while S₂(i,j) for each position(i,j) in the respective area 221 in the second fusing coefficient field 22 may be set as 0. With such settings, the area corresponding to the object part of the masking upon the image fusing may fully use the image value in the first area image block, that is, the image value of the object to be detected in the medical image indicated by the object part of the masking, regardless of the image value in the second area image block that does not contain the object to be detected.

In some other embodiments, especially when the size of the masking is not exactly the same as that of the area 20, for example, when the area 203 other than the object part 201 of the masking and the peripheral part 202 around the object part of the masking exists as shown in FIG. 2, S₁(i,j) for each position(i,j) in the area 213 outside the area corresponding to the masking in the first fusing coefficient field 21 may be set as 0. Correspondingly, S₂(i,j) for each position(i,j) in the area 223 outside the area corresponding to the masking in the second fusing coefficient field 22 may be set as 1. With such settings, the area outside the masking upon the image fusing may fully use the original image values in the second area image block, regardless of the image values in the first area image block. In other words, the image fusing based on the first area image block and the second area image block is performed only in the area corresponding to the masking, and areas other than the masking retain the original image values of the second area image block.

In some other embodiments, S₁(i,j) and S₂(i,j) for each position(i,j) in the peripheral part 202 around the object part of the masking may be determined by a distance d(i,j) to the boundary of the object part of the masking. The closer to the boundary of the object part of the masking, i.e., the lower d(i,j) is, the higher S₁(i,j) is, and correspondingly, the lower S₂(i,j) is. That is, the change of S₁(i,j) and S₂(i,j) shows opposite trend. In some embodiments, for example, in the case of normalization, for any position (i,j) in the peripheral part around the object part of the masking, the sum of S₁(i,j) and S₂(i,j) is 1. With such a setting, when data fusing is performed in the peripheral part 202 around the object part of the masking, the closer to the object part 201 of the masking, the greater the influence of the first area image block. Otherwise, the influence of the second area image block gradually increases with the increase of the distance to the object part 201 of the masking.

In a case where S₁(i,j), S₂(i,j), d(i,j) and d_Q are defined as above, for example, S₁(i,j) and S₂(i,j) may have a relationship as described in Formula (1) below:

$${S}_{1} ( i , j ) = \{ \begin{matrix}0 & d ( i , j ) > d\_Q \\ \frac{d\_Q - d ( i , j )}{d\_Q} & d ( i , j ) < d\_Q\end{matrix} , {S}_{2} ( i , j ) = 1 - {S}_{1} ( i , j ) \qquad Formula ( 1 )$$

In some embodiments, after S₁(i,j) and S₂(i,j) for each position(i,j) in the area 20 are determined, the image value I_{new}(i,j) for each position(i,j) in the composite area image block may be calculated in accordance with any applicable rules by performing the image fusing based on a masking including an object part and a peripheral part around the object part. As an example, weight fusion of I₁(i,j) and I₂(i,j) may be made according to Formula (2):

I_{new}(i,j)=I₁(i,j)*S₁(i,j)+I₂(i,j)*S₂(i,j) Formula (2)

wherein I_{new}(i,j) is an image value for position (i,j) in the composite area image block, and I₁(i,j) and I₂(i,j) are respectively the image value for position (i,j) in the first area image block and the second area image block.

The above Formula (1) and Formula (2) are only examples instead of limitations. In some other embodiments, other applicable calculation methods may also be used for S₁(i,j) and S₂(i,j). For example, when it may be determined by other means that the boundary of the object to be detected in the first area image block is clear, and the object part 201 of the defined masking can accurately represent the boundary of the object to be detected, S₁(i,j) may be set such that it approaches 0 faster with the increase of d(i,j), so that the characteristics of the object to be detected in the fused composite area image block are closer to those of the actual object to be detected. In some other embodiments, other image fusing methods may also be used to utilize S₁(i,j) and S₂(i,j) to calculate I_{new}(i,j), for example, an image fusing method with nonlinear weight, so that the fused composite area image block has a more realistic effect.

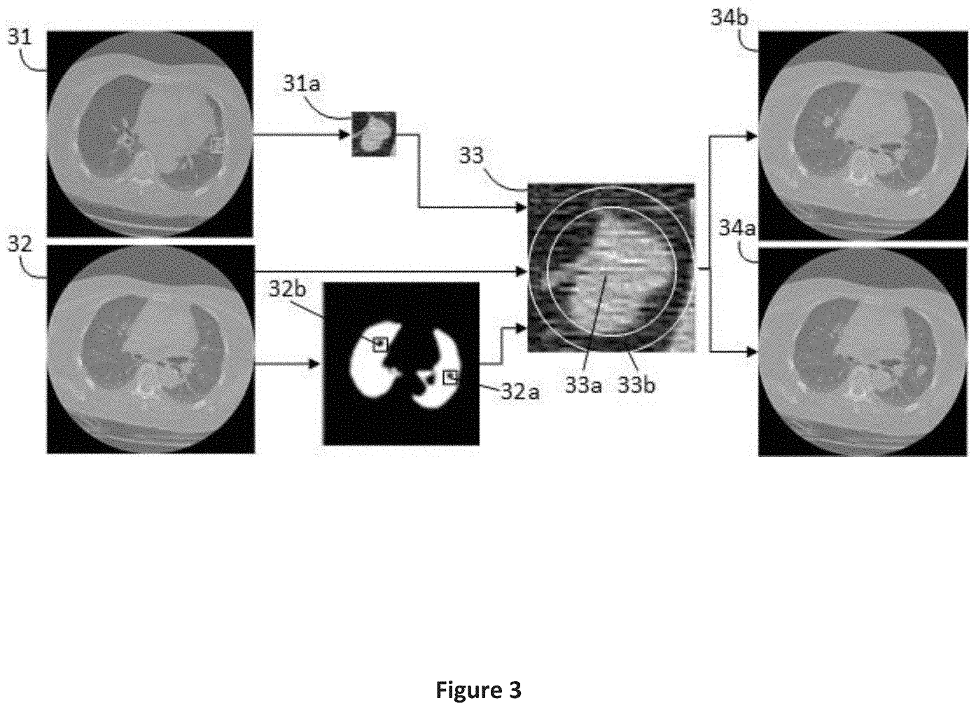

Next, an example of fusing the image blocks based on the masking according to an embodiment of the present disclosure will be described with reference to FIG. 3.

In this example, it is assumed that by comparing with the actual distribution of pulmonary lesion, it is found that the amount of the image samples, in which the attribute of the object is the pulmonary lesion distributed in the lung lobe (for example, pulmonary nodule), contained in the medical image sample set is small. Therefore, in this embodiment, taking a pulmonary nodule as a pulmonary lesion as an example, an image 31 containing a pulmonary nodule and an image 32 not containing a pulmonary nodule as shown in FIG. 3 are randomly selected from the medical image sample set. However, it should be noted that the pulmonary lesion is not necessarily the pulmonary nodule, and in other embodiments, it may also be any other type of pulmonary lesions.

Then, an image block 31a containing a pulmonary nodule lesion is intercepted from the image 31 containing the pulmonary nodule for the subsequent image fusing. The two image blocks 32a marked with boxes in the image are the image blocks for composing a pulmonary nodule in the lung lobe area selected from the image 32 not containing the pulmonary nodule. The black dots in the image blocks are the center points for the composing of a pulmonary nodule. The masking 33 in FIG. 3 is defined according to the pulmonary nodule lesion contained in the image block 31a, and includes the object part of the masking and the peripheral part around the object part, as shown in the circular area 33a in the central section of the masking 33 and the surrounding annular area 33b respectively.

Next, by using the masking 33, the image block 31a containing the pulmonary nodule lesion as the first area image block and the image block 32a in the left lung lobe as the second area image block are fused to generate a composite area image block (not shown) of the left lung lobe. The composite area image block is then embedded back into the image 32 as the second medical image to generate a new image 34a with a nodule lesion contained in the new left lung lobe as shown in FIG. 3. Similarly, by using the masking 33, the image block 31a containing the pulmonary nodule lesion as the first area image block and the image block 32b in the right lung lobe as the second area image block are fused to generate a composite area image block (not shown) of the right lung lobe. The composite area image block is then embedded back into the image 32 as the second medical image to generate a new image 34b with a nodule lesion contained in the right left lung lobe. The generated third medical image containing the nodule lesion may be added to the medical image sample set as a new sample to achieve the date enhancement of the original medical image sample set.

In the above example, by using one medical image containing the pulmonary nodule in the lung lobe in the sample set, two new medical images with pulmonary nodule in different positions of the left lung lobe and the right lung lobe are generated, which effectively makes up the attribute of the object of pulmonary nodule in the lung lobe lacking in the medical image sample set. The same attribute is added in a convenient and efficient way. However, due to the different composition positions of the lesion having the attribute of this object, the new medical image samples finally generated have sufficient difference. Therefore, the enhancement of the medical image sample set can be effectively realized. In some embodiments, it is possible that, according to the actual lack of the attributes of the object and the actual distribution of positive and negative samples in the sample set, one first medical image is selected to correspond to one second medical image, and one or more third medical images are generated at different positions that meet the requirement of the attributes of the object. For example, the identified lacking attribute of the object in the above example is pulmonary nodule in the lung lobe, and when selecting the image block to be composed in the second medical image, all lung lobe areas are candidate areas that meet the requirement. In some other embodiments, it is also possible to select one first medical image corresponding to multiple second medical images to generate multiple third medical images with diversified characteristics.

In some embodiments, the number of the generated third medical images having the lacking attribute of the object may be determined based on whether the data distribution of the attribute of the object in real scenario is closed to or reached, or may be based on whether the detection accuracy of the attribute of the object by the data-enhanced medical image sample set reaches an expected value.

In some other embodiments, it is necessary to consider that when machine learning is performed based on the enhanced medical image sample set, there will be no adverse effects, such as over-fitting, on the learning of the attribute of the object.

The medical image sample set enhanced in the above way can not only enhance specific object attributes, such as the amount of pulmonary nodule lesions in the lung lobe, but also improve the diversity of samples. Therefore, in practical applications, when detecting the object to be detected by using a machine learning network, such as a neural network, trained with the sample set enhanced in this way, higher detection accuracy will be obtained, and the deep learning model trained with the data-enhanced medical image sample set will also have better generalization ability.

In some embodiments, the generated third medical image having the lacking attribute of the object may data-enhance the medical image sample set in the way of offline expansion. In some other embodiments, the medical image sample set may also be expanded online in the way of online enhancement. The specific enhancement manner may be determined according to the capacity of the image sample set or the like.

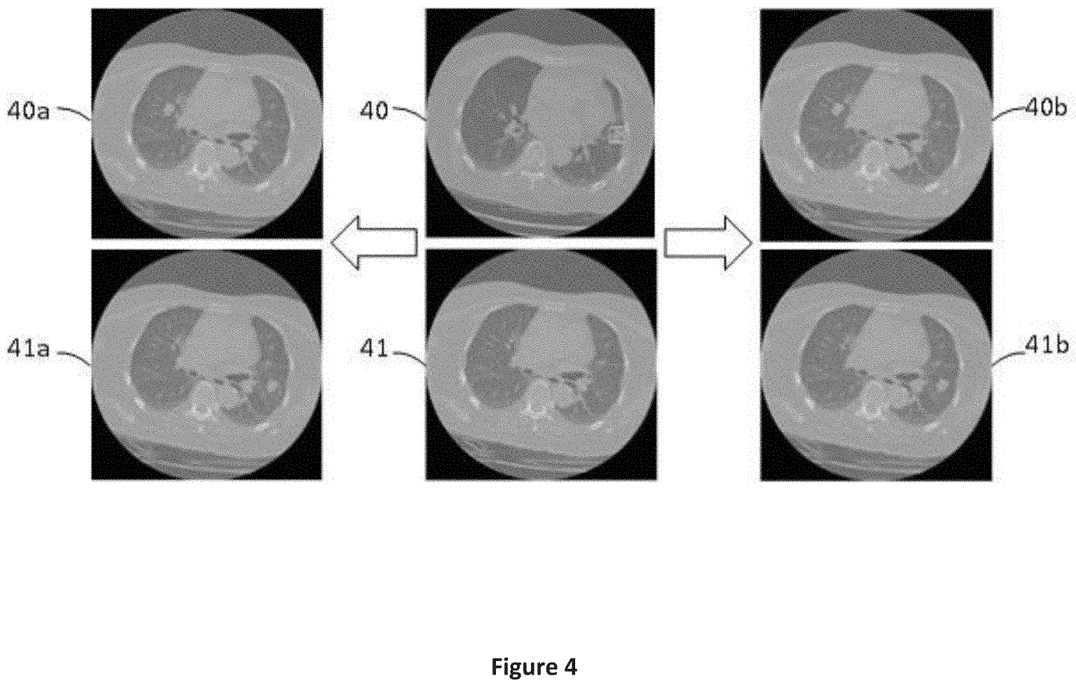

FIG. 4 shows a comparison of the effects between a new nodule image generated by fusing the image blocks based on a masking according to an embodiment of the present disclosure and a new nodule image generated by a conventional manner of copy-move method. In FIG. 4, the image 40 is an image in which the pulmonary nodule is contained in the lung lobe selected from the medical image sample set, and the image 41 is an image in which the pulmonary nodule is not contained in the lung lobe selected from the medical image sample set. The image 40a and the image 41a are respectively two new medical images containing the pulmonary nodules, which are generated through a traditional copy-move manner respectively, i.e., by copying the image block containing the pulmonary nodule in the image 40, and moving into the right lung lobe and the left lung lobe of the image 41. It can be seen from the image 40a and the image 41a that due to the simple copy-move method, there are obvious boundary traces around the pulmonary nodules, leading to a big gap between them and the medical image taken naturally. On the contrary, in the new medical images 40b and 41b containing the pulmonary nodules generated by the method of fusing the image blocks based on the masking according to the embodiment of the present disclosure, there is no obvious boundary trace around the pulmonary nodules, which is well fused with the original medical image and is very close to the medical image taken naturally. It is easy to conceive of that when the image 40a and the image 41a are added to the original medical image sample set for the training of the machine learning network such as the neural network, the above boundary trace can be considered as an undesired noise introduced artificially, which may lead to false recognition, and the effect of enhancing the medical image sample set cannot be obtained. The new nodule image generated by fusing the image blocks based on the masking according to the embodiment of the present disclosure will not bring the above adverse effects that lead to false recognition during machine learning training, and can effectively enhance the original medical image sample set.

The following is the embodiments of a device of the present disclosure, which may be used to implement the method embodiment of the present disclosure. For details not disclosed in the device embodiment of the present disclosure, please refer to the method embodiment of the present disclosure.

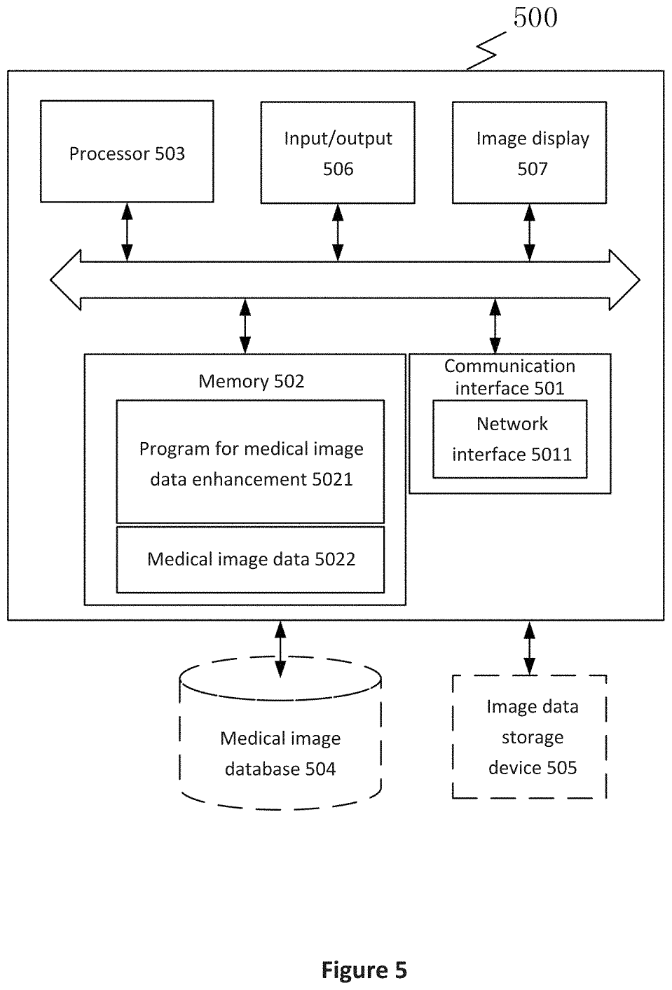

FIG. 5 shows a schematic diagram of a device for medical image data enhancement according to an embodiment of the present disclosure. In some embodiments, a device 500 for data enhancement for medical image detection may be a dedicated intelligent device or a general intelligent device. For example, the device 500 may be a computer customized for image data processing tasks, or a cloud server. For example, the device 500 may be integrated into an image processing device.

As an example, the device 500 for data enhancement for medical image detection may at least include a communication interface 501, a memory 502 and a processor 503.

In some embodiments, the communication interface 501 is used to obtain a medical image sample set related to an object to be detected. For example, the communication interface 501 may receive data about the medical image sample set via a communication cable, wireless local area network (WLAN), wide area network (WAN), wireless network (such as radio wave, cellular or telecommunication network, and/or local or short-range wireless network, e.g., Bluetooth™) or other communication manners.

In some embodiments, the communication interface 501 may include an integrated service digital network (ISDN) card, a cable modem, a satellite modem or a modem to provide data communication connection. In such an implementation, the communication interface 501 may send and receive electrical, electromagnetic and/or optical signals via direct communication link, which carries analog/digital data streams representing various types of information. In some other embodiments, the communication interface 501 may also include a local area network (LAN) card (e.g., an Ethernet adapter) to provide a data communication connection to a compatible LAN. As an example, the communication interface 501 may also include a network interface 5011 via which the device 500 may be connected to a network (not shown), such as, but not limited to, a local area network or the Internet in a hospital. The network may connect the device 500 for data enhancement of medical image detection with an external device such as an image acquisition device (not shown), a medical image database 504 and an image data storage device 505. The image acquisition device may be any device that acquires an image of an object, such as a DSA imaging apparatus, an MRI imaging apparatus, a CT imaging apparatus, a PET imaging apparatus, an ultrasound apparatus, a fluoroscopy apparatus, a SPECT imaging apparatus, or other medical imaging apparatus used to obtain a medical image of a patient. For example, the imaging device may be a lung CT imaging device, etc.

In some embodiments, the communication interface 501 may be used to add the third medical image generated by the processor 503 to the medical image sample set to obtain a data-enhanced medical image sample set.

In some embodiments, the device 500 for data enhancement for medical image detection may additionally include at least one of an input/output 506 and an image display 507.

The processor 503 may be a processing device that includes more than one general processing device, such as a micro-processor, a central processing unit (CPU) and a graphics processing unit (GPU), etc. More specifically, the processor 503 may be a complex instruction set computing (CISC) micro-processor, a reduced instruction set computing (RISC) micro-processor, a very long instruction word (VLIW) micro-processor, a processor that runs other instruction sets or a processor that runs a combination of instruction sets. The processor 503 may also be more than one dedicated processing device, such as dedicated Integrated circuit (ASIC), field programmable gate array (FPGA), digital signal processor (DSP) and system on chip (SoC). As those skilled in the art will understand, in some embodiments, the processor 503 may be a dedicated processor instead of a general-purpose processor. The processor 503 may include one or more known processing devices, such as any of microprocessors of Pentium™, Core™, Xeon™ or Itanium™ series manufactured by Intel, microprocessors of Turion™ Athlon™, Sempron™, Opteron™, FX™, Phenom™ series manufactured by AMD, or microprocessors manufactured by Sun Microsystems. The processor 503 may further include graphics processing units, such as GPU from GeForce®, Quadro®, and Tesla® series manufactured by Nvidia, and GPU of GMA, Iris™ series manufactured by Intel™, or GPU of Radeon™ series manufactured by AMD. The processor 503 may further include accelerated processing units, such as desktop A-4 (6, 8) series manufactured by AMD and Xeon Phi™ series manufactured by Intel. The disclosed embodiments are not limited to any type of processor or processor circuit, which are configured in other ways to meet the following computational requirements: performing the method for data enhancement for medical image detection according to various embodiments of the present disclosure, for example. In addition, the term “processor” or “image processor” may include more than one processor, for example, a multi-core design or a plurality of processors, each of which has a multi-core design. The processor 503 can execute a sequence of computer program instructions stored in the memory 502 to execute various operations, processes, methods disclosed by this document.

The processor 503 may be communicatively coupled to the memory 502 and configured to perform computer-executable instructions stored therein. The memory 502 may include read-only memory (ROM), flash memory, random access memory (RAM), such as synchronous DRAM (SDRAM) or Rambus DRAM dynamic random access memory (DRAM), static memory (e.g., flash memory, static random access memory), etc., on which computer-executable instructions are stored in any format. In some embodiments, the memory 502 may store computer-executable instructions of one or more programs 5021 for medical image data enhancement. The computer program instructions may be accessed by the processor 503, read from ROM or any other suitable storage location, and loaded into the RAM for execution by the processor 503. For example, the memory 502 may store one or more of software application programs. The software application programs stored in the memory 502 may include, for example, an operating system (not shown) and a soft control device for a general-purpose computer system. In addition, the memory 502 may store the entire software application program or only a part of the software application program (for example, the programs 5021 for data enhancement of medical image detection) to be executable by the processor 503. In addition, the memory 502 may store a plurality of software modules for achieving the method for data enhancement for medical image detection, or individual steps in the process of training the learning network for medical image detection, consistency with the present disclosure. In addition, the memory 502 may store data generated/cached when performing the computer program, such as the medical image data 5022 that includes medical images sent from an image acquisition device, a medical image database 504, an image data storage device 505, etc. Such medical image data 5022 may include a received medical image sample set to be detected to which the detecting of the lacking attribute of the object is to be performed.

In addition, the medical image data 5022 may also include a medical image selected from the medical image sample set to be fused so as to compose a new medical image having the lacking attribute of the object, and each new composed medical image.

The processor 503 may execute the program 5021 for data enhancement for medical image detection to implement the method for data enhancement for medical image detection. In some embodiments, when executing the program 5021 for data enhancement for medical image detection, the processor 503 may associate the data on the detected lacking attribute of the object with the first medical image and the second medical image selected from the medical image sample set to be fused to compose a new image having the lacking attribute of the object. Each composed third medical image is stored into the memory 502. In some embodiments, the memory 502 may communicate with the medical image database 504 via the communication interface 501, and add each third medical image generated by the processor 503 into the medical image sample set in the medical image database 504 to obtain a data-enhanced medical image sample set.

In some embodiments, the learning network for medical image detection may be stored in the memory 502. In some other embodiments, the learning network for medical image detection may be stored in a remote apparatus, a discrete database (such as the medical image database 504), a distributed apparatus, and may be used by a program 5021 for data enhancement for medical image detection.

The input/output 506 may be configured to allow the device 500 for data enhancement for medical image detection to receive and/or send data. The input/output 506 may include one or more digital and/or analog communication apparatus that allow the device 500 to communicate with users or other machines and devices. For example, the input/output 506 may include a keyboard and mouse that allow the user to input.

The network interface 5011 may include a network adaptor, a cable connector, a serial connector, an USB connector, a parallel connector, a high-speed data transmission adaptor such as optical fiber, an USB 3.0, a lightning, a wireless network adaptor such as wiki adaptor, a Telecommunication (3G, 4G/LTE, etc.) adaptor. The device 500 may connect to the network through the network interface 5011. The network may provide functions of local area network (LAN), wireless network, cloud computing environment (e.g., software as a service, platform as a service, infrastructure as a service, etc.), client server, wide area network (WAN), etc.

In addition to display the medical image, the image display 507 may display other information, such as image and/or text information about the attribute of the object lacking in the medical image sample set, a bounding box indicating the masking range, etc. For example, the image display 507 may be an LCD, CRT, or LED display.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. It is intended, therefore, that the descriptions and examples be considered as examples only, with a true scope and spirit being indicated by the following claims and their full scope of equivalents.

The above description is intended to be illustrative, and not restrictive. For example, the above-described examples (or one or more aspects thereof) may be used in combination with each other. Other embodiments can be used by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method for medical image data enhancement, comprising:
receiving, by a communication interface, a medical image sample set related to an object to be detected;
based on an attribute of the object lacking in the medical image sample set, selecting, by a processor, a first medical image and a second medical image from the medical image sample set, wherein the first medical image contains the object lacking the attribute, and the second medical image does not contain the object lacking the attribute;
determining a first area image block encompassing an area containing the object lacking the attribute in the first medical image;
determining a second area image block encompassing an area not containing the object lacking the attribute in the second medical image;
generating a composite area image block, by the processor, by fusing the first area image block and the second area image block based on a masking including an object part and a peripheral part around the object part;
embedding, by the processor, the composite area image block back into the second medical image to obtain a third medical image; and
including the third medical image in the medical image sample set to obtain a data-enhanced medical image sample set.

2. The method according to claim 1, wherein said fusing the first area image block and the second area image block further comprises:
for each position in each part of the masking, fusing image information at the position of the first area image block and image information at the position of the second area image block respectively based on a first fusing coefficient and a second fusing coefficient.

3. The method according to claim 2, wherein for each position in the peripheral part of the masking,
the closer a position to the object part, the larger the first fusing coefficient and the smaller the second fusing coefficient.

4. The method according to claim 1, wherein a size of the first area image block and a size of the second area image block are the same, and a size of the peripheral part of the masking matches the size of the first area image block.

5. The method according to claim 1, further comprising:
determining the attribute of the object lacking in the medical image sample set using a trained model.

6. The method according to claim 5, wherein determining the attribute of the object lacking in the medical image sample set using a trained model further comprises:
detecting a distribution of the attributes of the object by applying the trained model to the medical image sample set; and
comparing the detected distribution of the attributes of the object with the actual distribution of the attributes of the object.

7. The method according to claim 5, further comprising:
training the model based on the data-enhanced medical image sample set.

8. The method according to claim 1, wherein the first medical image and the second medical image are randomly selected.

9. The method according to claim 1, wherein the attribute includes at least one of a predetermined subtype of the object, a predetermined position of the object, or a predetermined size of the object.

10. The method according to claim 9, wherein, when the object is a pulmonary lesion, the predetermined subtype of the object includes a solid lesion, a ground-glass lesion or a semi-solid lesion.

11. The method according to claim 9, wherein, when the object is a pulmonary lesion, the predetermined position of the object is inside lung lobes or inside a thorax.

12. The method according to claim 2, wherein for each position in the object part of the masking, the first fusing coefficient is 1, and the second fusing coefficient is 0.

13. The method according to claim 2, wherein in the first area image block, the first fusing coefficient for each position outside of an area corresponding to the masking is 0, and in the second area image block, the second fusing coefficient for each position outside of the area corresponding to the masking is 1.

14. The method according to claim 2, wherein for each position in the peripheral part of the masking, a sum of the first fusing coefficient and the second fusing coefficient is 1.

15. The method according to claim 2, wherein an image value for each position in the composite area image block is:
I_{new}(i,j)=I₁(i,j)*S₁(i,j)+I₂(i,j)*S₂(i,j)
wherein I_{new}(i,j) is image value for position (i,j) in the composite area image block, I₁(i,j) and I₂(i,j) are respectively image values of the first area image block and the second area image block for position (i,j), and S₁(i,j) and S₂(i,j) are respectively the first fusing coefficient and the second fusing coefficient for position (i,j).

16. The method according to claim 2, wherein the first fusing coefficient and the second fusing coefficient for each position in the peripheral part of the masking are calculated as follows:
$${S}_{1} ( i , j ) = \{ \begin{matrix}0 & d ( i , j ) > d\_Q \\ \frac{d\_Q - d ( i , j )}{d\_Q} & d ( i , j ) < d\_Q\end{matrix} , {S}_{2} ( i , j ) = 1 - {S}_{1} ( i , j )$$
wherein S₁(i,j) and S₂(i,j) are respectively the first fusing coefficient and the second fusing coefficient for position(i,j), d(i,j) is the minimum distance between the position (i,j) and the boundary of the object part of the masking, and d_Q is the minimum distance from all points on the boundary of the peripheral part of the masking to the boundary of the object part of the masking.

17. A device for medical image data enhancement, comprising:
a communication interface configured to receive a medical image sample set related to an object to be detected; and
a processor configured to:
based on an attribute of the object lacking in the medical image sample set, selecting a first medical image and a second medical image from the medical image sample set, wherein the first medical image contains the object lacking the attribute, and the second medical image does not contain the object lacking the attribute;
determine a first area image block encompassing an area containing the object lacking the attribute in the first medical image;
determine a second area image block encompassing an area not containing the object lacking the attribute in the second medical image;
generating a composite area image block by fusing the first area image block and the second area image block based on a masking including an object part and a peripheral part around the object part;
embedding the composite area image block back into the second medical image to obtain a third medical image; and
including the third medical image in the medical image sample set through the communication interface to obtain a data-enhanced medical image sample set.

18. The device according to claim 17, wherein fusing the first area image block and the second area image block further comprises:
for each position in each part of the masking, fusing image information at the position of the first area image block and image information at the position of the second area image block respectively based on a first fusing coefficient and a second fusing coefficient.

19. The device according to claim 18, wherein, for each position in the peripheral part of the masking,
the closer a position to the object part, the larger the first fusing coefficient and the smaller the second fusing coefficient.

20. A non-transitory computer readable storage medium having computer executable instructions stored thereon, wherein the computer executable instructions, when executed by a processor, implement a method for medical image data enhancement, wherein the method comprises:
receiving a medical image sample set related to an object to be detected;
based on an attribute of the object lacking in the medical image sample set, selecting a first medical image and a second medical image from the medical image sample set, wherein the first medical image contains the object lacking the attribute, and the second medical image does not contain the object lacking the attribute;
determining a first area image block encompassing an area containing the object lacking the attribute in the first medical image;
determining a second area image block encompassing intercepting an area not containing the object lacking the attribute in the second medical image;
generating a composite area image block by fusing the first area image block and the second area image block based on a masking including an object part and a peripheral part around the object part;
embedding the composite area image block back into the second medical image to obtain a third medical image; and
including the third medical image in the medical image sample set to obtain a data-enhanced medical image sample set.
